(19) United States
(12) Patent Application Publication
(10) Pub. No.: US 2004/0066036 A1
(43) Pub. Date: Apr. 8, 2004

(54) Conduit with corrugated end

(76) Inventor: Guy Estran, Guiscard (FR)

Correspondence Address: YOUNG & THOMPSON, 745 SOUTH 23RD STREET 2ND FLOOR, ARLINGTON, VA, 22202

(21) Appl. No.: 10/332,364

(22) PCT Filed: Jul. 2, 2001
(86) PCT No.: PCT/FR01/02110

(30) Foreign Application Priority Data
Jul. 12, 2000 (FR) 00 09085

(51) Int. Cl. F16L 9/00

(52) U.S. Cl. 285/252; 138/109; 138/120; 138/155; 138/DIG. 11

(57) ABSTRACT

The invention relates to a pipe having at least one end portion (2) forming a section for coupling onto a rigid endpiece (7) and containing an inner tubular jacket (5) of elastic material. According to the invention, at least one longitudinally-extending indentation (4) is formed in the end portion (2) of the pipe (1). The invention is applicable in coupling a pipe to a member to which it is to be connected in the field of fluid transport.

The invention-relates to a pipe for conveying fluid, the pipe having at least one end forming a section for coupling to an endpiece of a member to which it is to be connected. Such pipes are used, for example, in power-assisted steering systems for cars in order to connect the tank containing steering liquid to the pump, or indeed in fuel circuits. The invention also relates to the coupling made with such a pipe.

To couple the pipe to a rigid endpiece of a tank that has an end enlargement, it is known to use a flexible sleeve mounted inside one end of the pipe. The pipe is secured to the endpiece by means of a clamping collar placed on the pipe between its own end and the end enlargement of the endpiece so as to compress the pipe and the sleeve radially onto the endpiece. The sleeve then seals the connection, either because of the tightness of the collar, or because a flange on the sleeve is pressed against the end face of the pipe.

The pipe is put into place by forcing the pipe fitted with its sleeve onto the endpiece, and then placing the clamping collar on the pipe. The force required for engagement purposes makes a major contribution to the cost and the difficulty of the engagement operation.

To reduce this force which is due essentially to the low elasticity of the pipe, proposals have been made to increase the thickness of the sleeve to greater than the minimum thickness that suffices for obtaining satisfactory leaktightness.

This gives rise to a sleeve of excessive weight and size, making it necessary to provide a pipe with increased end diameter. In addition, the engagement force often remains too high.

In another known method, proposals have been made to form longitudinal slots in the end of the pipe. This provides devices that are easy to engage. However, it is not possible to make such slots while extruding the pipe. It is therefore necessary to make them in an additional operation which is expensive and runs the risk of leaving burrs that can be harmful to the cleanness required of pipes in this kind of application. Furthermore, the risk of leaks is increased because the fluid passing between the sleeve and the pipe will find a passage to the outside through the slots.

There therefore exists a need that has not yet been solved in convenient manner for a pipe having a coupling section that is easy to engage and that is leaktight on the endpiece of the member to which it is to be connected.

According to the invention, the invention provides, for this purpose, a pipe having at least one end portion forming a section for coupling onto a rigid endpiece and containing an inner tubular jacket of elastic material, the pipe being remarkable in that at least one longitudinally-extending indentation is formed in the end portion of the pipe.

The indentation serves to impart the necessary radial elasticity to the end of the pipe to make it easy to engage the pipe on the endpiece.

Preferably, the end portion has indentations formed around its entire circumference.

This ensures that the indentations act uniformly over the entire periphery of the sleeve.

In which case, the inside diameter of the indentations is selected to cause the jacket to be clamped onto the endpiece.

This provides fluid tightness between the endpiece and the jacket.

Advantageously, a non-indented cylindrical portion is provided on the end portion between the indented portion and the pipe proper.

For endpieces having an enlarged end, the enlargement can be received in said cylindrical portion, thus enabling the indented portion that has been deformed radially by the enlargement to shrink onto the cylindrical portion of the endpiece.

According to an important feature, the end portion of the pipe is terminated by an enlarged cylindrical portion.

This terminal enlargement is intended to provide a face that comes to bear against the flange of the sleeve, so as to provide leaktightness between the pipe and the sleeve.

Other characteristics of the invention appear more clearly in the light of the following description of a particular embodiment of the invention described with reference to the accompanying figures, in which:

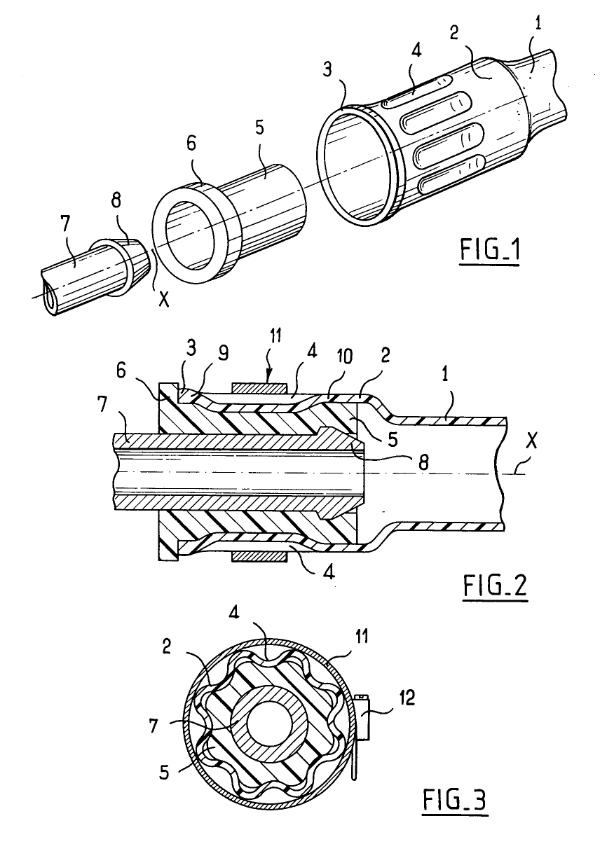

FIG. 1 is a perspective view of a pipe of the invention;

FIG. 2 is a longitudinal section view of the pipe; and

FIG. 3 is a section view perpendicularly to the axis of the pipe.

In FIG. 1, there can be seen a pipe 1 of axis X having an end 2 of inside diameter that is adapted to receive in conventional manner an internal tubular jacket in the form of a resilient sleeve 5. In the applications concerned, the pipe 1 is made of polyamide, for example, and therefore presents low elasticity. The sleeve 5 is made of an elastomer type material, for example cellular polyvinyl chloride or rubber, presenting a high degree of elasticity.

The sleeve 5 possesses a flange 6 for pressing against the end face 3 of the pipe 1. The end 2 possesses longitudinally-extending indentations 4. These indentations impart radial elasticity to the end 2 suitable for facilitating engagement of an endpiece 7 fitted with an end enlargement 8.

These indentations are formed in the pipe 1 by a corrugated extrusion process that is simple to implement and of low cost, and that does not require any subsequent reworking, thus avoiding any risk of burrs and the need to use additional tooling.

FIG. 2 which is a longitudinal section view on the axis X, shows the pipe 1 connected to the endpiece 7. During engagement, the end enlargement 8 expands the sleeve 5, which in turn expands the end 2, relying on the elasticity conferred thereto by the indentations 4.

Advantageously, the ordinary portion of the pipe 1 is caused to begin beyond a cylindrical portion 10 left on the end 2 downstream from the indentations 4 in the engagement direction so as to enable the indented zone to shrink radially onto the cylindrical portion of the endpiece 7 after the end enlargement 8 has gone past. This ensures that the endpiece 7 is clamped radially by the indented end zone 2 of the pipe 1 via the sleeve 5. The resistance opposed by the indented zone to being expanded radially acts in addition to the friction between the various elements in providing means that are very simple for preventing the pipe 1 being separated in untimely manner from the endpiece 7 merely by applying traction.

The flange 6 presses against the end face 3 of the pipe 1 which is connected to an enlarged cylindrical end portion 9 upstream from the indentations 4 in the engagement direction.

Sealing is provided firstly by clamping between the sleeve 5 and the endpiece 8 in the cylindrical zone by means of the indentations 4, and secondly by the flange 6 pressing against the end face 3 of the pipe 1 as provided on the end enlargement 9.

The connection between the pipe 1 and the endpiece 7 is made secure by a collar 11 which is put into place and tightened around the end 2 over the indentations 4. It is not necessary to clamp the collar 11 in order to seal the connection, since sealing is already provided by the indentations 4. The collar 11 serves only to prevent the indentations 4 expanding radially in the event of traction being applied to the pipe 1.

FIG. 3 is a section view through the end of the preceding figure level with the indentations 4, and it shows the undulating configuration of the end 2 of the pipe 1. The indentations 4 press the sleeve 5 onto the endpiece 7. The indentations 4 are prevented from expanding radially by the collar 11 clamped around them, the collar being put into place and then clamped by means of a conventional screw device 12, for example.

The invention is not limited to the particular embodiment described above, but on the contrary extends to cover any variant which uses equivalent means to reproduce the essential characteristics specified above.

In particular, the end 2 may be fitted to the pipe 1; sealing between the end 2 and the sleeve 5 may be obtained by compressing the sleeve so that it fits closely to the shape of the end 2; the connection is still good even if the endpiece 7 does not possess an end enlargement 8. Under such circumstances, clamping the collar 11 serves to hold the pipe 1 on the endpiece 7 by friction. The sleeve 5 may be a tubular insert molded onto the pipe 1.

1/ A pipe having at least one end portion (2) forming a section for coupling onto a rigid endpiece (7) and containing an inner tubular jacket (5) of elastic material, the pipe being characterized in that at least one longitudinally-extending indentation (4) is formed in the end portion (2) of the pipe (1).

2/ A pipe according to claim 1, characterized in that the end portion (2) has indentations formed around its entire circumference.

3/ A pipe According to any preceding claim, characterized in that the inside diameter of the indentation (4) is selected to cause the jacket (5) to be clamped onto the endpiece (7).

4/ A pipe according to any preceding claim, characterized in that the end portion (2) of the pipe (1) is terminated by an enlarged cylindrical portion (9).

5/ A pipe according to any preceding claim, characterized in that a non-indented cylindrical portion (10) is provided on the end portion (2) between the indented portion and the pipe (1) proper.
